(19) United States
(12) Patent Application Publication
(10) Pub. No.: US 2010/0082412 A1
(43) Pub. Date: Apr. 1, 2010

(54) SYSTEM AND METHOD FOR OPTIMIZING AN ADVERTISEMENT PLAN FOR ALLOCATING ADVERTISEMENTS TO A CONTRACT IN A NETWORK-BASED ENVIRONMENT

(75) Inventors: Chad Brower, Campbell, CA (US); Ramana Yerneni, Cupertino, CA (US); Erik Vee, San Mateo, CA (US); Serguei Vassilvitskii, New York, NY (US); Jayavel Shanmugasundaram, Santa Clara, CA (US); Danny Zhang, Mountain Valley, CA (US); Srinivasan Rajagopal, San Jose, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/242,696

(22) Filed: Sep. 30, 2008

(51) Int. Cl. G06Q 30/00

(52) U.S. Cl. 705/14.4

(57) ABSTRACT

The present invention is directed to a system and method for optimizing an advertisement plan for allocating advertisements to a contract in a network-based environment. The system and method includes determining a shadow price for an advertisement placement where the advertisement placement is associated with a user having defined characteristics. The system and method includes determining a contract price for the advertisement placement relative to a plurality of advertisement contracts for the user having the defined characteristics. The system and method includes determining an advertisement plan for allocating an advertisement to a given contract on the basis of the shadow price and the contract price. The system and method includes presenting a given advertisement associated with the given contract according to the advertisement plan on network-based output.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to advertising, more specifically to the optimization of an advertisement plan for allocating advertisements to a contract in a network-based environment.

### BACKGROUND OF THE INVENTION

Since the widespread acceptance of the Internet, advertising as a main source of revenue has proven to be both effective and lucrative. Advertising on the Internet provides the additional benefit of allowing advertisers to more effectively target audiences viewing their advertisements as opposed to traditional print and “hard copy” advertising which constitute a one-way flow of information: advertisers to users.

The very nature of the Internet facilitates a two way flow of information between users and advertisers and allows these transactions to be conducted in real time or near-to-real time. For example, a user may request an ad and may intentionally, or inherently, transmit various pieces of data describing himself or herself. Additionally, an advertising management system may be able to intelligently determine which ads to place on a given website requesting advertisement content, increasing the revenue for both parties involved and increasing user satisfaction by eliminating “nuisance” ads, or those ads in which a user is not interested.

The current state of the art, however, fails to fully exploit the interactive aspects of the Internet in the advertising realm. Most current advertising systems need to coordinate a number of components such as components for forecasting web traffic, targeting demographics, procuring ad placements and publishing ads. Each component relies on the cooperative and reliable performance of the others.

Unfortunately, current advertising systems are decoupled. A decoupled system results in a number of inconsistencies with respect to contracts for the placement and delivery of advertisements. Even just a slight overestimation of future web traffic may jeopardize an advertising system's ability to deliver the advertisements promised. Likewise, an underestimation hurts advertisers and publishers alike because of lost opportunities for ad placements.

Current systems create a strict and artificial separation between display inventory of available advertisement placements that is sold many months in advance in a guaranteed fashion (guaranteed delivery), and inventory that is sold in using a real-time auction in a market or through other means (non-guaranteed delivery). For instance, the Yahoo!® advertising system may serve guaranteed contracts their desired quota before serving non-guaranteed contracts, creating an unnecessary and inefficient bias toward guaranteed contracts. While acceptable in the past, the shift in the advertising industry demands a mix of guaranteed and non-guaranteed contracts.

Another flaw with the decoupled advertising system is the failure to take advantage of the stores of information available when pricing contracts and allocating advertisements to advertisement placements. For example, the current pricing systems only use advertising information and contract information at a coarse and untargeted level. The failure to mine and use information regarding how advertisement placements may be allocated at a more granular level creates a gap between the price paid for an advertisement placement and the actual value that a contract derives from the advertisements placed.

This failure leads to the inability to provide more refined and targeted advertisements. Increased refinement in targeting allows advertisers to reach a more relevant customer base. The frustration of advertisers moving from broad targeting parameters (e.g., “1 million Yahoo! Finance users) to more fine-grained parameters (e.g., “100,000 Yahoo! Finance users from September 2008-December 2008 who are California males between the ages of 20-35 working in the health care industry”) is evident. Unfortunately, the increased refinement and targeting is simply not computationally pragmatic with the current system design.

Accordingly, there exists a need for a more unified marketplace for the optimization of an advertisement plan and allocation of advertisements to a contract in a network-based environment.

### SUMMARY OF THE INVENTION

The present invention is directed to a system and method for optimizing an advertisement plan for allocating advertisements to a contract in a network-based environment. The system and method includes determining a shadow price for an advertisement placement where the advertisement placement is associated with a user having defined characteristics. The system and method includes determining a contract price for the advertisement placement relative to a plurality of advertisement contracts for the user having the defined characteristics. The system and method includes determining an advertisement plan for allocating an advertisement to a given contract on the basis of the shadow price and the contract price. The system and method includes presenting a given advertisement associated with the given contract according to the advertisement plan on network-based output.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a system for optimizing an advertisement plan for allocating advertisements to a contract in a network-based environment;

FIG. 2 illustrates a flowchart of one embodiment of a method for optimizing an advertisement plan for allocating advertisements to a contract in a network-based environment;

FIG. 3 illustrates a flowchart of one embodiment of a method for optimizing an advertisement plan for allocating advertisements to a contract in a network-based environment where the determination of the advertisement plan is based on a shadow price and a contract price;

FIG. 4 illustrates a flowchart of one embodiment of a method for optimizing an advertisement plan for allocating the advertisement to a given contract where the determination of the advertisement plan is based on a substantially uniform distribution; and

FIG. 5 illustrates a sample output display as generated by the system and method for optimizing an advertisement plan for allocating the advertisement to a given contract in a network-based environment.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

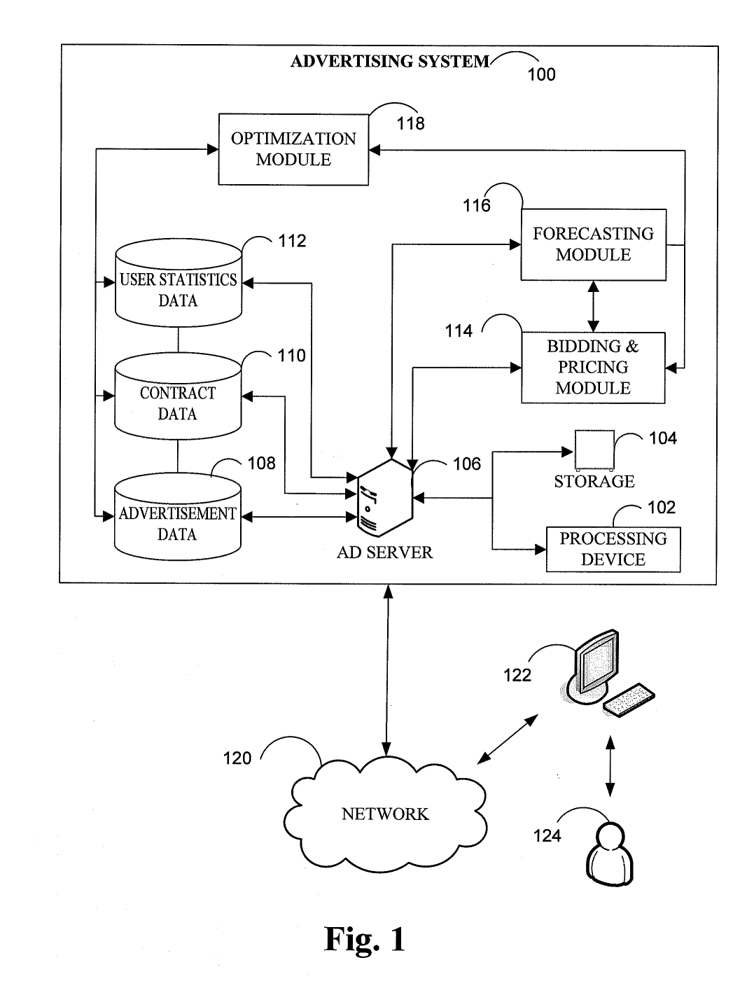

FIG. 1 illustrates an advertising system 100 including a processing device 102, a storage device 104 and an ad server 106. The advertising system 100 further includes an advertisement data store 108, a contract data store 110 and a user statistics data store 112. The advertising system further includes a bidding and pricing module 114, a forecasting module 116 and an optimization module 118. FIG. 1 also illustrates a network 120, a network-based output 122, and user 124.

The processing device 102 may be any suitable type of processing device operative to perform processing operations in response to executable instructions, wherein the executable instructions provide for processing operations as described in further detail herein. The storage device 104 may be any suitable type of storage device operative to store the executable instructions on a computer readable medium such that upon transmission to the processing device 102, the processing device 102 is operative to perform the processing operations as described herein.

The ad server 106 may be one or more server devices operative to perform server operations, including interfacing with the advertisement data store 108, the contract data store 110, the user statistics data store 112, the bidding and pricing module 114, the forecasting module 116 and an optimization module 118. The ad server 106 computer may be further operative to receive and transmit information over a network 120 to users 124 through the network-based output 122.

In one embodiment, the ad server 106 may be operative to establish and manage communication among and between a plurality of hardware devices, data stores, modules, networks, network-based outputs, and users. This communication may utilize communication protocols and/or techniques consistent with knowledge of one skilled in the art. In one embodiment, the ad server 106 may be a plurality server processing devices managing Internet connectivity between users, such as, for example a publicly available Internet search engine, where user 124 accesses a web site for search request operations.

In another embodiment, the ad server 106 may receive a query from an advertiser with contract terms specifying a target. For example, the query may specify Yahoo! finance users who are California males with an interest in sports and autos. The ad server 106 may return the available advertisement placements for the specified target and a contract price. An advertiser may then book the contract through an interface presented on the network-based output 122. With the contract stored in the contract data store 110, the ad server 106 may receive an advertisement opportunity over the network 120. The advertisement opportunity may include information about of the user, a URL of the webpage being accessed by the user and the like. The ad server 106 may then send an advertisement with the amount that the advertiser is willing to pay to the bidding and pricing module 114. The bidding and pricing module 114 may then determine to place the advertisement in the advertisement placement presented by the opportunity.

The advertisement data store 108 may include advertising information usable by the advertising system 100 for distributing advertisements to network-based outputs. The advertisement data store 108 may be any number of databases or data storage devices having advertising information therein. Advertising information may include, but is not limited to, an advertisement plan, advertisement content or media, advertisement metadata, advertiser information, publisher information, advertisement placements, advertisement opportunities and advertisement performance analytics. Additionally, the ad server 106 may include additional processing operations or procedures relating to the selection of particular ads and the placement of those ads in network-based outputs, wherein the selection of the particular advertisement may be aided by the processing operations of the processing device 102 in performing processing steps using information from any of the data stores 108, 110, 112 or modules 114, 116, 118 in communication with the advertising system.

The contract data store 110 may include contracting information usable by the advertising system 100, the contracting information relating to terms and conditions for the placement of a number of advertisement placements as requested by the advertiser. The contract data store 110 may be any number of databases or data storage devices having a plurality of contracts, contract requirements, marketing information, etc. Additionally, the ad server 106 may include additional processing operations or procedures relating to the procurement of advertisement placements consistent with the requirements of a given contract. For example, the additional operations or procedures may include receiving a contract time interval and targeting a demographic of users having defined characteristics.

The user statistics data store 112 may include user statistics information usable by the advertising system 100 in forecasting network traffic, traffic volume for users having defined characteristics, and associated advertising information. The user statistics data store 112 may be any number of databases or data storage devices having user information usable for various purposes, including predicting a volume of users having defined characteristics. Additionally, the ad server 106 may include additional processing operations or procedures relating to the periodic or dynamic updating of user statistics information, the addition of new users, network traffic, demographic and historical information.

The optimization module 118 may include any number of optimizing processes or procedures implemented in software or hardware, or a combination thereof. The optimization module 118 may be operative to receive information from and transmit information to the advertisement data store 108, the contract data store 110, the user statistics data store 108, and the ad server 106. Through the ad server 106, the optimization module 118 may be placed in communication with users on a network-based output 122 through the network 120.

The optimization module 118 may be further operative to be in communication with the bidding and pricing module 114 as well as the forecasting module 116. When in communication with the forecasting module 116, the optimization module 118 may be operative to periodically or dynamically receive forecasting information comprising a number of future advertisement placements or impressions, actual contract information and a prediction of future contracts. The optimization module 118 may be further operative to process information for determining an advertising plan.

In one embodiment, an advertising plan comprises the allocation and distribution of advertisements to the advertisement placements predicted. A summary of the advertisement plan may be transmitted to the ad server 106 and to the bidding and pricing module 114. The advertisement plan may be updated periodically or dynamically on the basis of receiving additional forecasting information or additional information regarding network traffic. Given a plan, the ad server 106, upon receiving an advertisement opportunity may calculate the contention among contracts, to be described in more detail below. When used in combination with the forecasting information, information stored in data stores 108, 110, 112, and the contention information, the ad server 106 may select a contract and generate a bid for the contract in an effort to procure an advertisement placement presented by an advertisement opportunity.

In one embodiment, the advertising plan is periodically or dynamically updated and transmitted to the forecasting module 116, bidding and pricing module 114 and the ad server 106.

The forecasting module 116 may include any number of forecasting processes or procedures implemented as software or hardware, or a combination thereof. The forecasting module 116 may be operative to determine the current availability of advertisement placements given any number of parameters. Some of those parameters may include user characteristics, marketing information and contract time intervals. In one embodiment, the forecasting module 116 uses a scalable multi-dimensional database indexing technique, such as bit-map indexing, for capturing and storing correlations between any number of user characteristics.

The forecasting module 116 may be further operative to determine contention between multiple contracts in the contract data store 110. In one embodiment, the forecasting module 116 may generate a sample data set, for example, impression samples, to determine contention between contracts as well as the number of contracts that may be satisfied. Forecasting information may be communicated to any number of suitable locations, such as the optimization module 118, the bidding and processing module 114, or to users 124 through the network 120 for additional processing.

The bidding and pricing module 114 may include any number of processes or procedures implemented as software or hardware, or a combination thereof. The bidding and pricing module 114 may be in communication with the advertisement data store 108, the contract data store 110, the user statistics data store 112, the optimization module 118, the forecasting module 116, the ad server 106 or with any number of users 124 through the network 120.

In one embodiment, the bidding and pricing module 114 is operative to update advertiser bids and prices for advertisement placements, automatically or otherwise. In one example, the bidding and pricing module 114 automatically calculates and updates an advertiser's bid or the price for an advertisement placement at a fixed time interval. The bidding and pricing module 114 may also be operative to receive notification from the optimization module 118 to update bidding and pricing information in response to distributing an advertisement or receiving an advertisement placement opportunity. In addition, the bidding and pricing module 114 may be operative to calculate and update the bids or prices for advertisement placements to be presented to a user having defined characteristics.

The preceding updates may be in response to a change in a bid from another advertiser for the user having similar characteristics. The preceding updates may also be in response to a variance between forecasting information regarding user traffic or the volume of users having defined characteristics and the actual user traffic or volume of users as they are received by the advertising system 100.

The network 120 may include any communications network (e.g., a wired/wireless LAN/WAN, a cellular network, the Internet, an intranet, a VPN, a PSTN, a VoIP, etc.). The network-based output 122 may include a general purpose personal computer comprising a processor, transient and persistent storage devices, input/output subsystem and bus to provide a communications path between components comprising the general purpose personal computer. Other network-based outputs are considered to fall within the scope of the present invention including, but not limited to, hand held devices, set top terminals, mobile handsets, PDAs, etc.

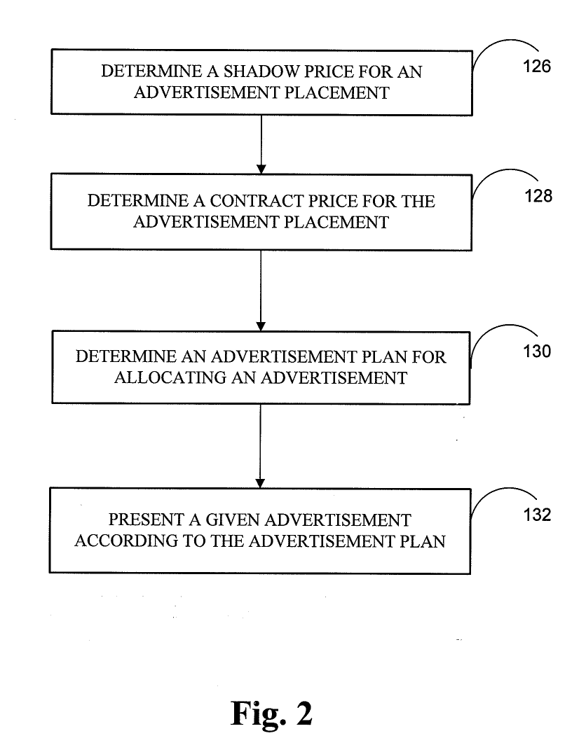

FIG. 2 illustrates a flowchart of one embodiment of a method for optimizing an advertisement plan for allocating advertisements to a contract in a network-based environment. The method includes, step 126, determining a shadow price. In one embodiment, a shadow price generally reflects the contention for an advertisement placement relative to a plurality of advertisement contracts for a user having defined characteristics. In other embodiments, the shadow price may reflect the contention for an advertisement placement relative to a variety of factors including time interval, geographic location, demographic profile, the context of the advertisement placement, etc. For example, the contention for an advertisement placement during a live streaming of the Super Bowl may be higher than the contention for an advertisement placement for less popular sporting events. Other factors relative to the determination of the contention for an advertisement placement will be apparent to one of ordinary skill in the art.

The next step is, step 128, determining a contract price for the advertisement placement. In one embodiment, a contract price generally reflects an advertiser's willingness to pay. A willingness to pay may depend on a variety of factors, including but not limited to, a time interval, the context of a particular advertisement placement, a plurality of users having defined characteristics, and the type of advertising technique used in presenting the advertisement. In another embodiment, the willingness to pay may depend on the particular advertising model employed. Particular advertising models may be impression-based, conversion-based, based on a return on advertisement spend (“ROAS”), or cost-per-acquisition (“CPA”) based.

The next step is determining an advertisement plan, step 130. With reference back to FIG. 1, the optimization module 118 may be operative to process information for determining an advertisement plan while in communication with the ad server 106. In one embodiment, the ad server 106 receives a potential contract comprising a target, duration, supply of available advertisement placements and demand for the advertisement placements. The ad server 106 and optimization module 118 may receive a sample of forecasting information from the forecasting module 116 and calculate a shadow price, the contention for the target.

To calculate the shadow price, we minimize Equation 1:

$$γ {\sum }_{j} {H}^{j} ( y {.}^{j} ) - {\sum }_{i} {r}_{i} {z}_{i} + {\sum }_{i} {p}_{i} ( {\sum }_{j ∈ {C}_{i}} {y}_{i}^{j} + {z}_{i} - {s}_{i} ) + {\sum }_{j} {α}^{j} ( {d}^{j} - {\sum }_{i ∈ {B}^{j}} {y}_{i}^{j} ) . \qquad Equation 1$$

where rᵢ is the reserve price for an advertisement placement i; sᵢ is the supply or available advertisement placements; d^{j} is the demand of contract j; yᵢ^{j} is the amount of an advertisement going to contract j; B^{j} is the set of advertisement placements that contract j wants, and Cᵢ is the set of contracts that want a given advertisement placement i. In Equation 1, the second line represents the supply of available advertisement placements and the third line represents the demand for the advertisement placements.

Solving to optimality yields the shadow price, denoted as pᵢ, and the contract price, denoted as α^{j}. Therefore, given any advertisement placement, the ad server 106 may calculate the shadow price. This may work even if the forecasting information does not include the specific advertisement placement in the sample set sent by the forecasting module. If the advertisement placement was in the sample set, then the shadow price may remain the same.

In one embodiment, the ad server 106 reconstructs the shadow price. To reconstruct the shadow price, we take the derivative of Equation 1 yielding Equation 2:

$$γ \frac{\partial }{\partial {y}_{i}^{j}} {H}^{j} + {p}_{i} - {α}^{j} . \qquad Equation 2$$

Next, the ad server 106 determines gᵢ^{j}, where gᵢ^{j} is the inverse of Equation 2 with respect to yᵢ^{j}, the amount of an advertisement placement to allocate to given contract, yielding Equation 3:

yᵢ^{j}=max{0, gᵢ^{j}(α^{j}−pᵢ)} Equation 3.

With the shadow price, the ad server 106 may determine an allocation plan. Assuming gᵢ^{j} is increasing; the optimal allocation may be denoted as y̅ in Equation 4 as follows:

$${g}_{i}^{j} ( γ \frac{\partial }{\partial {y}_{i}^{j}} {H}^{j} ( \overline{y} {.}^{j} ) ) = {\overline{y}}_{i}^{j} ( \overline{y} is optimal allocation ) . \qquad Equation 4$$

Again, with Equation 3 the ad server 106 may find the shadow price. The ad server may then compute the reserve price rᵢ and find the shadow price by setting pᵢ =rᵢ. Equation 5 may be given as:

$${\sum }_{j ∈ {C}_{i}} max \{ 0 , {g}_{i}^{j} ( {α}^{j} - {r}_{i} ) \} \leq {s}_{i} Set {p}_{i} = {r}_{i} . \qquad Equation 5$$

If Equation 5 does not hold, the ad server 106 may solve for pᵢ using Equation 6:

$${\sum }_{j ∈ {C}_{i}} max \{ 0 , {g}_{i}^{j} ( {α}^{j} - {p}_{i} ) \} = {s}_{i} Solve for {p}_{i} . \qquad Equation 6$$

At this point the ad server 106 can solve Equation 3 to get a hold of the Yᵢ^{j}. The ad server 106 may then receive the α^{j} as computed by the optimization module 118.

To allocate advertisement placements for a set of compatible contracts, the ad server 106 may solve Equation 5 for the reserve price, denoted as rᵢ, allocating the advertisement placement to a given contract with a sufficient contract price or willingness to pay, denoted as α^{j}. To find α^{j}, the ad server 106 may solve the following equation, Equation 7:

$${\sum }_{i ∈ {B}^{j}} max \{ 0 , {g}_{i}^{j} ( {α}^{j} - {p}_{i} ) \} = {d}^{j} . \qquad Equation 7$$

Therefore, when the ad server 106 receives an advertisement opportunity a set of compatible contracts may be found. With the reserve price, the ad server 106 may calculate the shadow price and determine the amount of an advertisement placement to allocate to given contract, denoted as yᵢ^{j} in Equation 4.

According to the embodiment of the method illustrated in FIG. 2, the next step is presenting a given advertisement according to the advertisement plan, step 132. In one embodiment, the ad server 106 retrieves an advertisement from the advertisement data store 108 and transmits the advertisement over the network 120 for display to a user 124. A given advertisement may comprise any number of media formats, including but not limited to, text, image, audio and video.

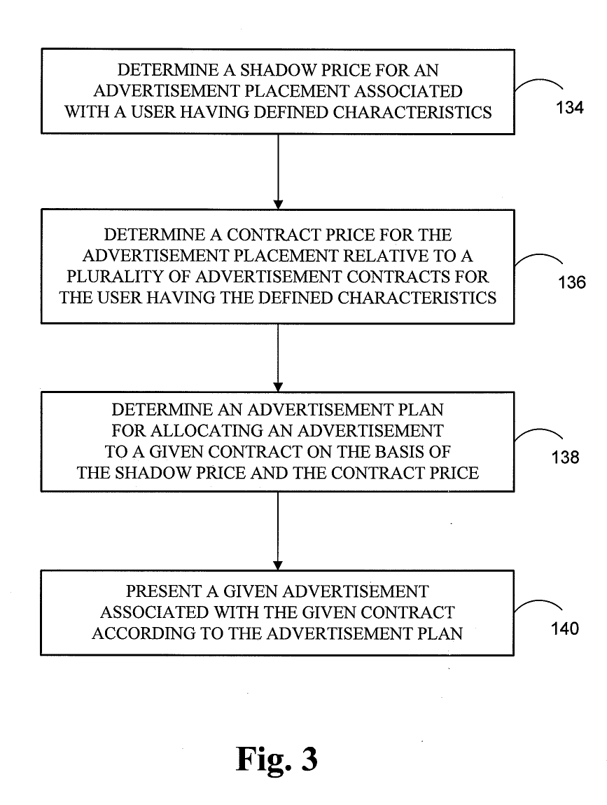

FIG. 3 illustrates a flowchart of one embodiment of a method for optimizing an advertisement plan for allocating advertisements to a contract in a network-based environment where the determination of the advertisement plan is based on a shadow price and a contract price. With reference back to step 126 of FIG. 2, the first step in FIG. 3, step 134, is determining a shadow price for an advertisement placement associated with a user having defined characteristics. In one embodiment, advertisers may specify a set of characteristics for users 124 while in communication with the advertising system 100.

For example, a geographic characteristic may include a broad value of America, a more narrow value of East coast, an even narrower value of New York, an even narrower value of New York City, a narrower value of zip code. The level of granularity for the geographic characteristic may be correlated with other characteristics such as age, gender, interest, sports team, political affiliation, and profession, by way of example. Each characteristic may be broken down into its own taxonomy. With a specific set of characteristics, the shadow price may be calculated as described in step 130 of FIG. 2.

The next step is determining a contract price for the advertisement placement relative to a plurality of advertisement contracts for the user having the defined characteristics, step 136. In one embodiment, this may be accomplished by receiving forecasting information for a given set of users having defined characteristics and identifying the contracts which may specify those characteristics. With the forecasting information and the contracts identified, the contract price may be determined by solving for α^{j} in Equation 7 as described in step 130 of FIG. 2.

In one embodiment, the optimization module 118 determines the contract price for an advertisement placement to be presented to a set of users having defined characteristics. For example, the optimization module 118 may receive a contract comprising a target profile of users having defined characteristics, a time interval or contract duration, and forecasting information. The optimization module 118 may then receive a set of forecasting information samples for the set of users having the defined characteristics. For each sample, a shadow price may be calculated as described in step 130 of FIG. 2. Using the shadow price, the optimization module 118 may approximate the contract price for a given advertisement placement as described in Equation 7 in step 130 of FIG. 2.

The next step is determining an advertisement plan for allocating an advertisement to a given contract on the basis of the shadow price and the contract price, step 138. This may be accomplished by incorporating the shadow price and contract price as calculated in step 130 of FIG. 2. The advertisement plan may also be adjusted on a variety of other factors, including but not limited to, agreements with partner sites, guaranteed advertising contracts, and bonus allocations.

The next step is presenting a given advertisement associated with the given contract according to the advertisement plan, step 140. In one embodiment, the ad server 106 retrieves an advertisement from the advertisement data store 108 and transmits the advertisement over the network 120 for display to a user 124. A given advertisement may comprise any number of media formats, including but not limited to, text, image, audio and video.

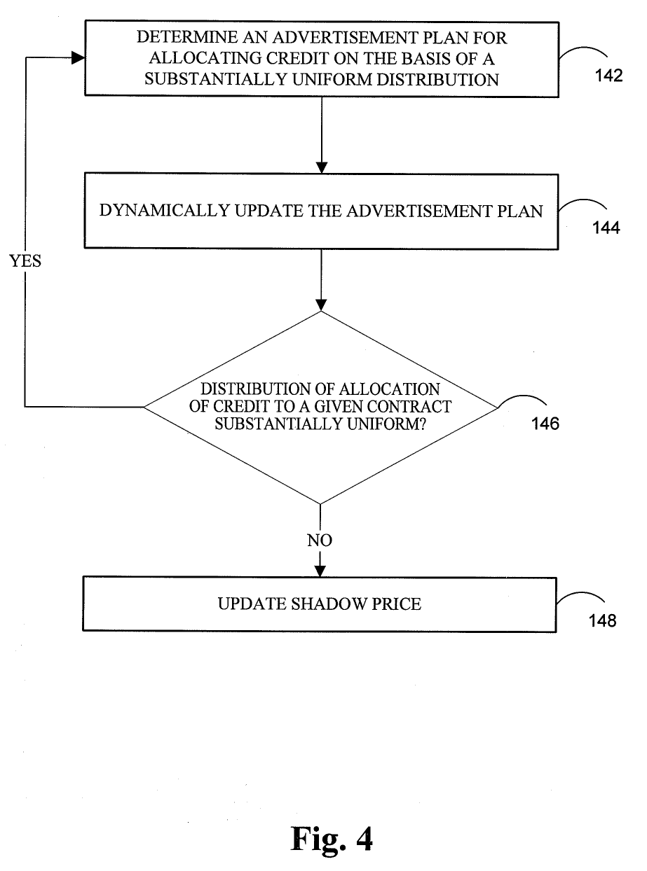

FIG. 4 illustrates a flowchart of one embodiment of a method for determining an advertisement plan for allocating the advertisement to a given contract where the determination of the advertisement plan is based on a substantially uniform distribution. The method includes, step 142, determining an advertisement plan for allocating credit on the basis of a substantially uniform distribution. Uniform distribution may include a desire for the allocation of advertisement placements to be substantially uniform over a temporal factor, a geographic factor, a demographic factor, or a combination of factors.

The next step, step 144, is dynamically updating the advertisement plan. An update may be accomplished offline, periodically or in real-time. In one embodiment, the optimization module 118 receives updated information from the ad server 106, the forecasting module 116, and the various data stores 108, 110, and 112. With updated information, the optimization module 118 may determine an updated advertising plan.

If the distribution of the allocation of credit to a given contract is substantially uniform, then the method returns to step 142, determining an advertising plan. If the distribution is unacceptable, the next step is adjusting the shadow price, step 148. The shadow price may be updated for a given set of users having defined characteristics. In one embodiment, an update to the shadow price is done in predefined intervals, adding or subtracting a variable amount on iteration. In another embodiment, an update to the shadow price may be a function of the equations described in step 130 of FIG. 2. Other ways of updating the shadow price may involve the time left on a given contract and will be apparent to those having skill in the art.

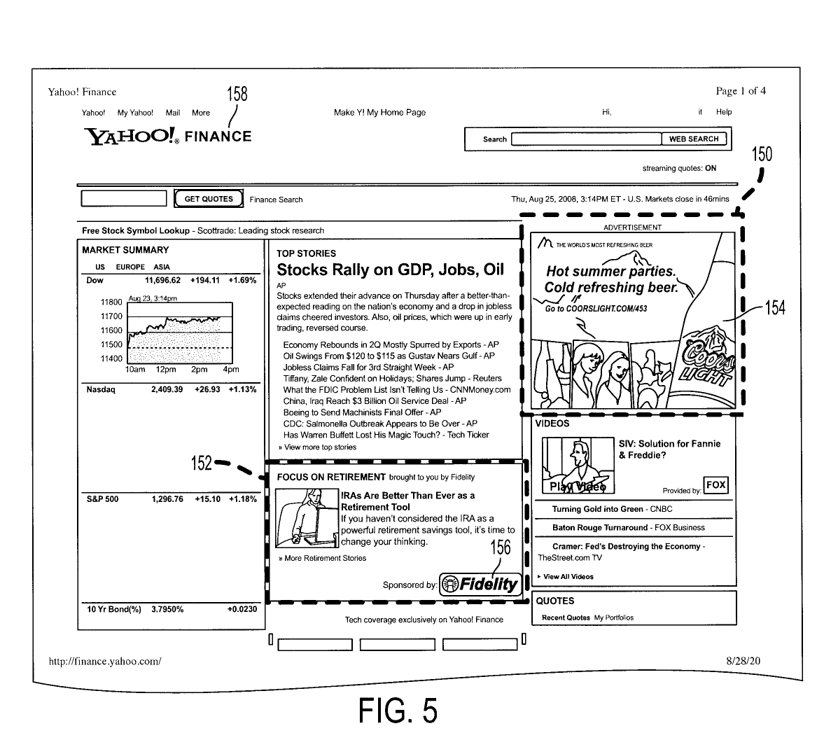

FIG. 5 illustrates a sample output display as generated by the system and method for distributing advertisements described herein. The sample output display may be generated by the advertising system 100 of FIG. 1 for display on the computer 122 via the network 120. Prior to display, the ad server 106 receives information about the user 124, recognizes that advertisement opportunities exist and conducts an electronic bidding operation for the placement of advertisements. The processing device 102 recognizes the advertisement opportunity consistent with at least one contract, such that the bidding and pricing module 114 calculates a bid amount and a corresponding bid is place in the ad server.

The sample output display of FIG. 5 includes a first advertisement placement 150 and a second advertisement placement 152, denoted by the dotted lines. These advertisement placements are directed relative to the user 124. As the sample output display may suggest, the advertisements 154 and 156 may be placed in the advertisement placements presented to users having an interest in finance 158 and sports as defined characteristics. This sample output display generated includes one advertisement from Coors Light® 154 and another sponsored by Fidelity( 156, where the advertisement 154 recognizes that the user may choose a beverage for consumption while watching a sporting event and advertisement 156 may which to entice the user 124 to explore investment opportunities with their company. As such, the output sample screen shot of FIG. 5 illustrates a representative display with advertisements selected based on the characteristics of the user and the fulfillment of corresponding advertisement contracts.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for optimizing an advertisement plan for allocating advertisements to a contract in a network-based environment, the method comprising:
determining a shadow price for an advertisement placement, the advertisement placement associated with a user having defined characteristics;
determining a contract price for the advertisement placement relative to a plurality of advertisement contracts for the user having the defined characteristics;
determining an advertisement plan for allocating an advertisement to a given contract on the basis of the shadow price and the contract price:
presenting a given advertisement associated with the given contract according to the advertisement plan on network-based output.

2. The method of claim 1 further comprising:
receiving an advertisement placement opportunity for a given user having defined characteristics;
allocating the advertisement placement opportunity for the given user according to the advertisement plan.

3. The method of claim 1 wherein the determination of the advertisement plan for allocating the advertisement to a given contract is also based on a substantially uniform distribution for the given contract.

4. The method of claim 3 wherein the substantially uniform distribution is associated with a time interval.

5. The method of claim 3 wherein the substantially uniform distribution is associated with a user type.

6. The method of claim 1 further comprising:
in response to presenting the given advertisement, dynamically updating the determination of the advertisement plan.

7. A system for allocating credit to a contract for placing advertisements in a network-based environment, the system comprising:
a computer readable medium having executable instructions stored thereon;
a processing device in communication with the computer readable medium operative to receive the executable instructions therefrom, the processing device, in response to the executable instructions, operative to:
determine a shadow price for an advertisement, the advertisement placement associated with a user having defined characteristics;
determine a contract price for the advertisement placement relative to a plurality of advertisement contracts for the user having the defined characteristics;
determine an advertisement plan for allocating an advertisement to a given contract on the basis of the shadow price and the contract price;
present a given advertisement associated with the given contract according to the advertisement plan on network-based output.

8. The method of claim 1 further comprising:
an ad server receiving an advertisement placement opportunity for a given user having defined characteristics;
a data storage device; and
the processing device, in response to executable instructions, further operative to allocate the advertisement placement opportunity for the given user according to the advertisement plan.

9. The system of claim 7 wherein the processing device, in response to executable instructions, is further operative to:
determine the advertisement plan for allocating the advertisement to a given contract according to a substantially uniform distribution for the given contract.

10. The system of claim 9 wherein the processing device, in response to executable instructions, is further operative to:
determine the advertisement plan for allocating the advertisement to a given contract according to a substantially uniform distribution associated with a time interval.

11. The system of claim 9 wherein the processing device, in response to executable instructions, is further operative to:
determine the advertisement plan for allocating the advertisement to a given contract according to a substantially uniform distribution is associated with a user type.

12. The system of claim 7 wherein the processing device, in response to executable instructions to present the given advertisement, is further operative to:
dynamically update the determination of the advertisement plan.

13. Computer readable media comprising program code that when executed by a programmable processor causes execution of a method for allocating credit to a contract for placing advertisements in a network-based environment, the computer readable media comprising:
program code for determining a shadow price for an advertisement placement, the advertisement placement associated with a user having defined characteristics;
program code for determining a contract price for the advertisement placement relative to a plurality of advertisement contracts for the user having the defined characteristics;
program code for determining an advertisement plan for allocating an advertisement to a given contract on the basis of the shadow price and the contract price;
program code for presenting a given advertisement associated with the given contract according to the advertisement plan on network-based output.

14. The computer readable media of claim 13, further comprising:
program code for receiving an advertisement placement opportunity for a given user having defined characteristics; and
program code allocating the advertisement placement opportunity for the given user according to the advertisement plan.

15. The computer readable media of claim 13 wherein the determination of the advertisement plan for allocating the advertisement to a given contract is also based on a substantially uniform distribution for the given contract.

16. The computer readable media of claim 15 wherein the substantially uniform distribution is associated with a time interval.

17. The computer readable media of claim 15 wherein the substantially uniform distribution is associated with a user type.

18. The computer readable media of claim 13, further comprising:
in response to presenting the given advertisement, program code for dynamically updating the determination of the advertisement plan.
